(19) United States
(12) Patent Application Publication
(10) Pub. No.: US 2010/0138483 A1
(43) Pub. Date: Jun. 3, 2010

(54) Data Reception Device, Data Transmission Device, and Data Distribution Method

(76) Inventors: Hitoshi Oitaira, Ome-shi (JP); Koichiro Kamura, Fujisawa-shi (JP); Tatsuya Kurozumi, Hachioji-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/620,369

(22) Filed: Nov. 17, 2009

(30) Foreign Application Priority Data
Nov. 28, 2008 (JP) 2008-304694

(51) Int. Cl. G06F 15/16

(52) U.S. Cl. 709/203

(57) ABSTRACT

According to one embodiment, a data reception device receiving data distributed by broadcast communication from a distribution server, comprises a detection module configured to detect other data reception devices which have already received the data among one or more other data reception devices on the basis of data reception device information in reception response information received by a reception response information reception module, and a reception response transmission module configured to transmit reception response information including data reception device information showing the other data reception devices and the data reception device detected by the detection module when the data reception module has received the data.

### CROSS-REFERENCE TO RELATED APPLICATIONS

This application is based upon and claims the benefit of priority from Japanese Patent Application No. 2008-304694, filed Nov. 28, 2008, the entire contents of which are incorporated herein by reference.

### BACKGROUND

1. Field

One embodiment of the invention relates to a data reception device for receiving data files transmitted to a plurality of destinations, a data transmission device for transmitting the data files to the plurality of destinations, and a data distribution method for receiving data files transmitted to the plurality of destinations.

2. Description of the Related Art

While there are various systems for distributing files from a server to a plurality of computers, among them there is a multicast system. The multicast system is used in a case where a plurality of computers requiring the same files exist.

A technique of transmitting a reception response packet including packet-specific information through the multicast system, as a response to a request packet, for equipment-specific information at a node participating in a multicast address is known (see Jpn. Pat. Appln. KOKAI Publication No. 2006-211698).

In general, since a data file to be distributed is large; the multicast system divides the data file into a plurality of data blocks and transmits the data blocks individually. At this moment, a computer (client) which has received these data blocks sends a reception response to the server by unicast.

As regards the problem at this time, since the response from a distributed client uses unicast, which utilizes user datagram protocol (UDP), if the reception response is lost on the network, the length of time it takes to detect the reception response is extremely deteriorated, which greatly deteriorates the data file distribution capability.

The reason it takes time to detect when the reception response has been lost on the network is not caused by the use of UDP. Distributing the response through UDP (multicast) to respond only the reception response through TCP (unicast) does not resolve the problem; however, it does not make much difference in time required to detect, and it benefits to leave lost detection processing to the TCP. Rather than this, the distribution server poses complicated and serious processing in order to effect to manage TCP connection to all the distribution clients.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view depicting a configuration of a distribution system regarding one embodiment of the invention;

FIG. 2 is an exemplary view depicting a protocol sequence example of a multicast distribution multicast response regarding the one embodiment of the invention;

FIG. 3 is an exemplary block diagram depicting a configuration of a distribution client regarding the one embodiment of the invention;

FIG. 4 is an exemplary view depicting an example of a reception response frame transmitted from a 23rd distribution client and received by a 24th distribution client;

FIG. 5 is an exemplary view depicting an example of data reception client information;

FIG. 6 is an exemplary view depicting an example of data reception client information corresponding to the reception response frames depicted in FIG. 4;

FIG. 7 is an exemplary view depicting an example of reception response frames generating from the 24th distribution client;

FIG. 8 is an exemplary block diagram depicting a configuration of the distribution client regarding the one embodiment of the invention;

FIG. 9 is an exemplary view depicting an example of data reception client information;

FIG. 10 is an exemplary view depicting an example of data reception client information in a case where a distribution server receives the reception response frames depicted in FIG. 4;

FIG. 11 is an exemplary view depicting an example of the data reception client information in a case where the distribution server receives the reception response frames depicted in FIG. 7;

FIG. 12 is an exemplary view depicting a procedure of processing to be performed by the distribution client during distribution; and

FIG. 13 is an exemplary view depicting a procedure of processing to be performed by the distribution server during distribution.

### DETAILED DESCRIPTION

Various embodiments according to the invention will be described hereinafter with reference to the accompanying drawings. In general, according to one embodiment of the invention, a data reception device receiving data distributed by broadcast communication from a distribution server, comprises a data reception module configured to receive the data distributed from the distribution server by broadcast communication to one or more other data reception devices including a first data reception device and to the data reception device, a reception response information reception module configured to receive reception response information, being transmitted by broadcast communication from the first data reception device to the distribution server and to the data reception device, and data reception devices except the first data reception device from the plurality of data reception devices, and including data reception device information showing data reception devices which have already received the data among the plurality of data reception devices when the first reception device receives the data, and a detection module configured to detect other data reception devices which have already received the data among one or more other data reception devices on the basis of data reception device information in the reception response information received by the reception response information reception module, and a reception response transmission module configured to transmit reception response information including data reception device information showing the other data reception devices and the data reception device detected by the detection module when the data reception module has received the data.

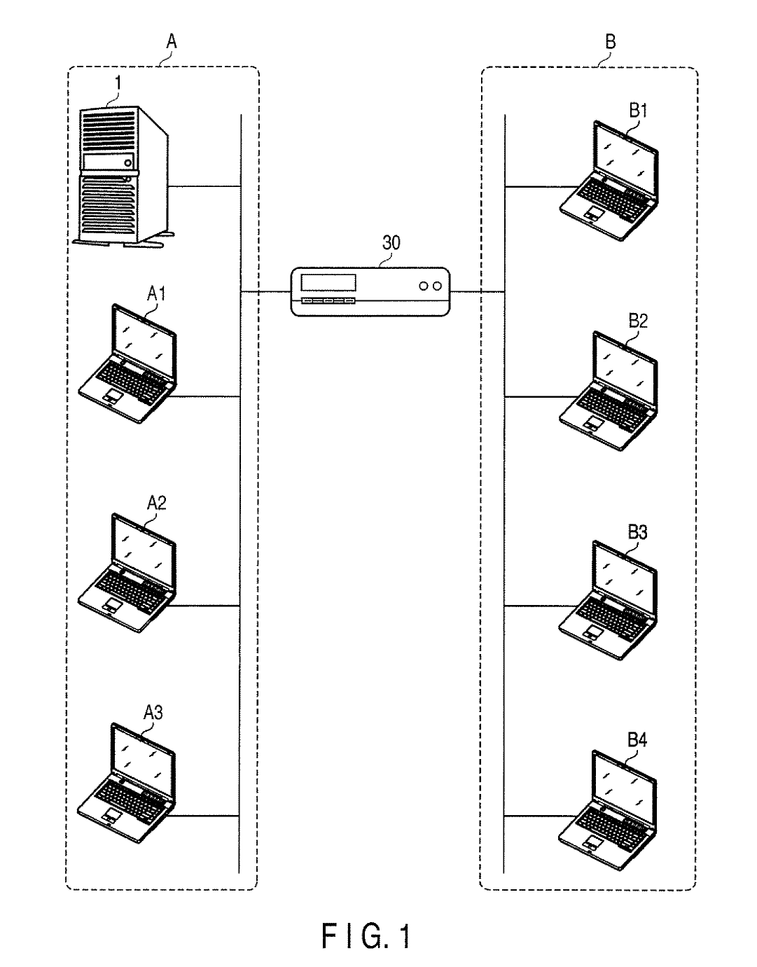

FIG. 1 shows a view illustrating a configuration of a distribution system regarding one embodiment of the invention.

As shown in FIG. 1, the distribution system consists of a first subnet A and a second subnet B. The first subnet A includes a distribution server 1, an 11th distribution client A1, a 12th distribution client A2, and a 13th distribution client A3. The first subnet A and the second subnet B may communicate with each other through a router 30. The second subnet B includes a 21st distribution client B1, a 22nd distribution client B2, a 23rd distribution client B3, and a 24th distribution client B4.

The distribution server 1 divides a data file into a plurality of data blocks to distribute each block to a plurality of clients A1-A3, B1-B4 by multicast communication that is broadcast communication. After distributing a certain data block, when receiving responses from all clients to which data blocks have been distributed, the distribution server 1 distributes the next block.

The distribution clients A1-A3, B1-B4 are clients to receive the data blocks distributed from the distribution server 1. When receiving the data blocks distributed from the distribution server 1, the distribution clients A1-A3, B1-B4 transmit reception response frames indicating that its own client received the data block to the distribution server 1.

Conventionally, since the response from the distribution client uses unicast communication using UDP, it takes time to detect a response in a case where the response has been lost on the network, and distribution performance may be extremely deteriorated. The distribution system of the embodiment is designed to shorten the time to detect the response.

In the distribution system, when receiving the data blocks from the distribution server 1, the distribution clients A1-A3, B1-B4 transmit reception client frames to the distribution server 1 and all the distribution clients by multicast communication. Since the transmission of the response frames to be transmitted from the distribution clients is performed by multicast communication, other distribution clients as well as the distribution server 1 receive the responses. At this moment, the distribution client transmits reception response frames including information of other distribution clients which have already received included in the reception response frames received by other distribution clients.

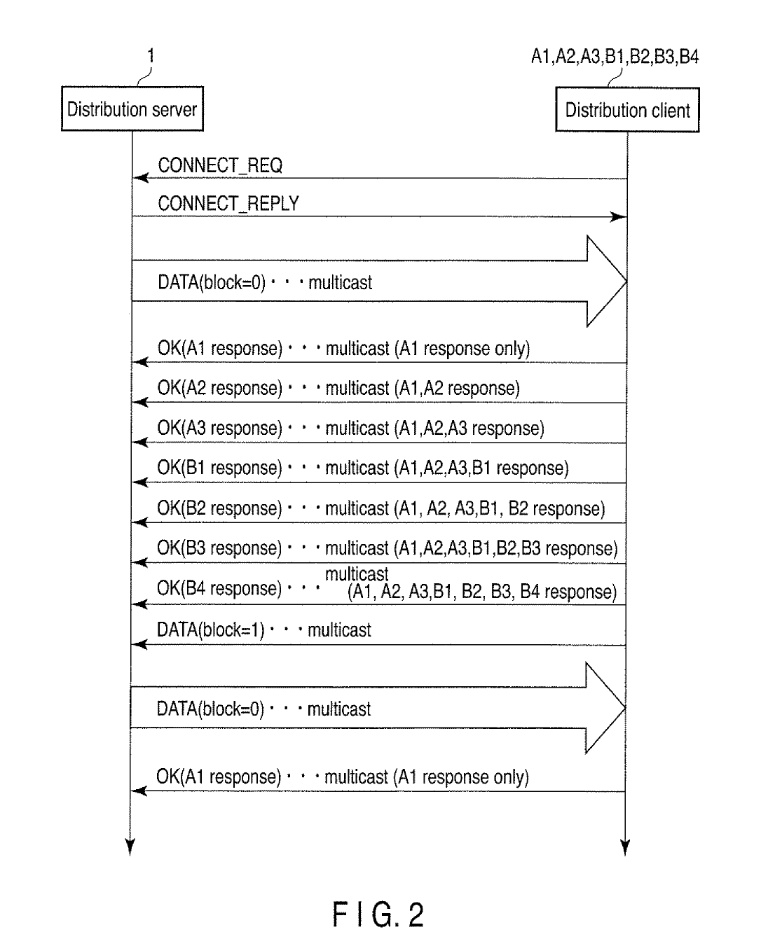

FIG. 2 shows a protocol sequence example of multicast distribution multicast responses.

As shown in FIG. 2, when being connected to the network, the distribution clients A1-A3, B1-B4 transmit “CONNECT_REQ” to the distribution server 1 to report to the distribution server 1 that the distribution clients A1-A3, B1-B4 have been connected to the network. The distribution server 1 transmits a “CONNECT_REPLY” to the distribution clients which have transmitted the “CONNECT_REQ” to report the reception thereof.

After this, the distribution server 1 distributes block data (block=0), which is the first block of a data file, to the distribution clients A1-A3, B1-B4.

When receiving block data (block=0), the 11th distribution client A1 transmits reception response frames to the distribution server 1, to the 12th distribution client A2, to the 13th distribution client A3, to the 21st distribution client B1, to the 22nd distribution client B2, to the 23rd distribution client B3, and to the 24th distribution client B4. The information of the client which has received the block data (block=0) included in the reception response frames transmitted from the 11th distribution client A1 relates to solely the 11th distribution client A1.

When receiving block data (block=0), the 12th distribution client A2 transmits reception response frames to the distribution server 1, to the 11th distribution client A1, to the 13th distribution client A3, to the 21st distribution client B1, to the 22nd distribution client B2, to the 23rd distribution client B3, and to the 24th distribution client B4. The information of the clients which have received the block data (block=0) included in the reception response frames transmitted from the 11th distribution client A1 concerns the 11th distribution client A1, and the 12th distribution client A2.

When receiving block data (block=0), the 13th distribution client A3 transmits reception response frames to the distribution server 1, to the 11th distribution client A1, to the 12th distribution client A2, to the 21st distribution client B1, to the 22nd distribution client B2, to the 23rd distribution client B3, and to the 24th distribution client B4. The information of the clients which have received the block data (block=0) included in the reception response frames transmitted from the 11th distribution client A1 relates to the 11th distribution client A1, the 12th distribution client A2, and the 13th distribution client A3.

When receiving block data (block=0), the 21st distribution client B1 transmits reception response frames to the distribution server 1, to the 11th distribution client A1, to the 12th distribution client A2, to the 13th distribution client A3, to the 22nd distribution client B2, to the 23rd distribution client B3, and to the 24th distribution client B4. The information of the client which have received the block data (block=0) included in the reception response frames transmitted from the 11th distribution client A1 relates to the 11th distribution client A1, the 12th distribution client A2, the 13th distribution client A3, and the 21st distribution client B1.

When receiving block data (block=0), the 22nd distribution client B2 transmits reception response frames to the distribution server 1, to the 11th distribution client A1, to the 12th distribution client A2, to the 13th distribution client A3, to the 22nd distribution client B2, to the 23rd distribution client B3, and to the 24th distribution client B4. The information of the clients which have received the block data (block=0) included in the reception response frames transmitted from the 22nd distribution client B2 relates to the 11th distribution client A1, the 12th distribution client A2, the 13th distribution client A3, the 21st distribution client B1, and the 22nd distribution client B2.

When receiving block data (block=0), the 23rd distribution client B3 transmits reception response frames to the distribution server 1, to the 11th distribution client A1, to the 12th distribution client A2, to the 13th distribution client A3, to the 21st distribution client B2, to the 22nd distribution client B3, and to the 24th distribution client B4. The information of the clients which have received the block data (block=0) included in the reception response frames transmitted from the 23rd distribution client B3 relates to the 11th distribution client A1, the 12th distribution client A2, the 21st distribution client B1, the 22nd distribution client B2, and the 23rd distribution client B3.

When receiving block data (block=0), the 24th distribution client B4 transmits reception response frames to the distribution server 1, to the 11th distribution client A1, to the 12th distribution client A2, to the 13th distribution client A3, to the 21st distribution client B2, to the 22nd distribution client B3, and to the 23rd distribution client B4. The information of the clients which have received the block data (block=0) included in the reception response frames transmitted from the 24th distribution client B4 relates the 11th distribution client A1, the 12th distribution client A2, the 13th distribution client A3, the 21st distribution client B1, the 22nd distribution client B2, the 23rd distribution client B3, and the 24th distribution client B4.

The following will describe a configuration of a distribution client and a distribution server so as to shorten the time required to detect the responses.

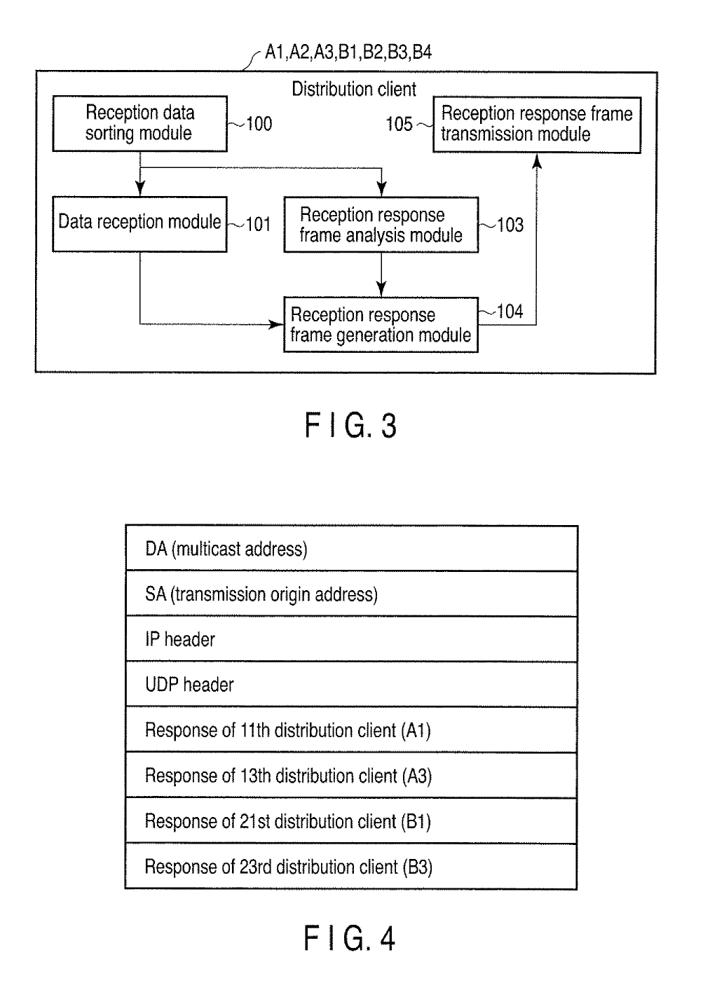

At first, the configuration of the distribution client will be described with reference to FIG. 3. FIG. 3 shows a block diagram illustrating the distribution clients A1, A2, A3, B1, B2, B3 and B4.

Each distribution client includes a data sorting module 100, a data reception module 101, a reception response frame analysis module 103, a reception response frame generation module 104 and a reception response frame transmission module 105.

The data sorting module 100 discriminates the kind of the reception data. For a data block, the data sorting module transfers the reception data to the data reception module 101 to report the reception of the data block to the reception response frame generation module 104. For a reception response frame, the data sorting module 100 transfers the reception data to the reception response frame analysis module 103.

The data reception module 101 couples the data block received by the distribution server 1 to restore the original data file.

The reception response frame analysis module 103 analyzes the reception response frame transferred from the data sorting module 100 to detect the distribution clients receiving the data block. If the distribution client that has transmitted the response receives responses from other distribution clients, the reception response frame includes the information of other distribution clients of which the response has been received by the distribution client who has transmitted the response.

For instance, FIG. 4 shows an example of a reception response frame transmitted from the 23rd distribution client B3 and received by the 24th distribution client B4. This example shows an example in which the 24th distribution client B4 receives the response frames from the 11th distribution client A1, the 13th client A3, the 21st distribution client B1 and the 23rd distribution client B3.

As shown in FIG. 4, the reception response frame includes a destination address (DA) multicast, a sender address (SA), an IP header, a UDP header, response of the 11th distribution client A1, a response of the 13th distribution client address A3, a response of the 21st distribution client B1, and a response of the 23rd distribution client B3. The response is information showing that the client has received the data block. That is, the reception response frame shows that the 11th distribution client A1, the 13th distribution client A3, the 21st distribution client B1 and the 23rd distribution client B3 have received the data blocks distributed from the distribution server 1.

For instance, in a case of the reception response frame shown in FIG. 4, it is detected that the 11th distribution client A1, the 13th distribution client A3, the 21st distribution client B1, and the 23rd distribution client B3 have received the data blocks.

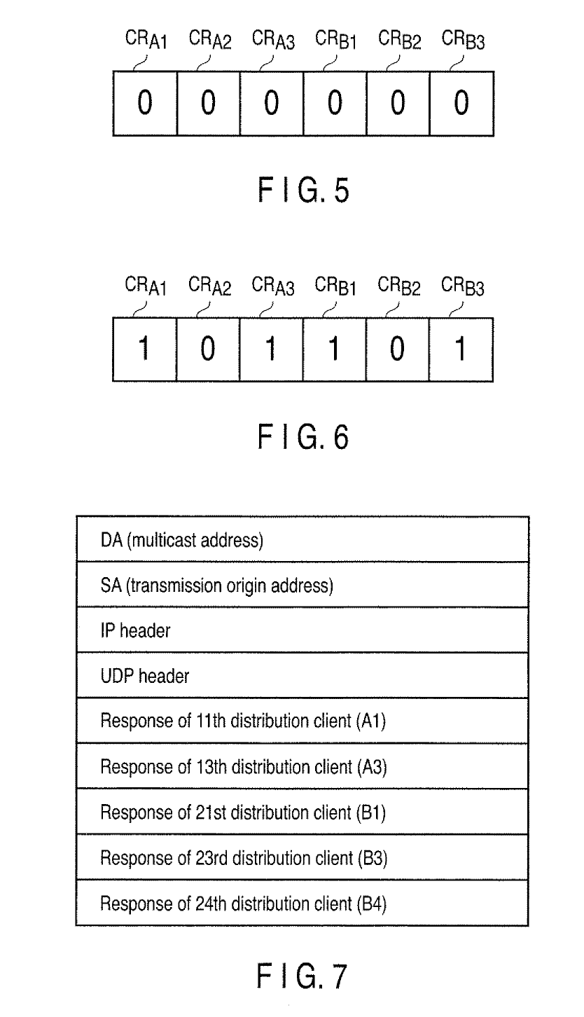

The reception response frame analysis module 103 has data reception client information showing the detected distribution clients. The data reception client information is, as shown in FIG. 5, composed of registers CR_{A1}, CR_{A2}, CR_{A3}, CR_{B1}, CR_{B2}, and CR_{B3} corresponding to all the clients except its own module. FIG. 5 shows data reception client information owned by the reception response frame analysis module 103 of the 24th distribution client B4, and the client information does not include the register corresponding to such module.

As shown in FIG. 5, a default value of each register is equivalent to “0” indicating non-reception. If the reception response frame analysis module 103 detects that a certain client has received the data block, the reception response frame analysis module 103 computes a logical add “OR” of a value of a register corresponding to the client that has received the data block and “1” indicating that the client has received the data block to update the value of the register to a computation result. This processing is performed until the own client transmits the reception response frame to the reception server 1. When transmitting the reception response frame to the distribution server 1, the reception response frame analysis module 103 resets the values of each register CR_{A1}, CR_{A2}, CR_{A3}, CR_{B1}, CR_{B2}, and CR_{B3} to “0”.

For instance, when the 24th distribution client B4 receives the reception response frames shown in FIG. 4, in the data reception client information, the values of the registers CR_{A1}, CR_{A3}, CR_{B1}, and CR_{B3} corresponding to the 11th distribution client A1, the 13th distribution client A3, the 21st distribution client B1 and the 23rd distribution client B3 become “1” as shown in FIG. 6.

When the data reception module 101 of own client receives the data block from the distribution server 1, the reception response frame generation module 104 generates the reception response frames so as to transmit such to the distribution server 1 on the basis of the information of the client that has received the data shown in the reception client information owned by the reception response frame analysis module 103. That is, for example, if the 24th distribution client B4 has received the reception response frame shown in FIG. 4, the generation module 104 generates the reception response frames in which the responses of the own client (the 24th distribution client) are added to the response frames shown in FIG. 4, as shown in FIG. 7.

The reception response frame transmission module 105 transmits the reception response frames generated from the reception response frame generation module 104 to the distribution server 1 and other distribution clients by multicast communication. For instance, in a case where the 24th distribution client B4 transmits the reception response frames shown in FIG. 7, the 24th distribution client B4 transmits the reception response frames to the first server 1, to the 11th distribution client A1, to the 12th distribution client A2, to the 13th distribution client A3, to the 21st distribution client B1, to the 22nd distribution client B2, and to the 23rd distribution client B3.

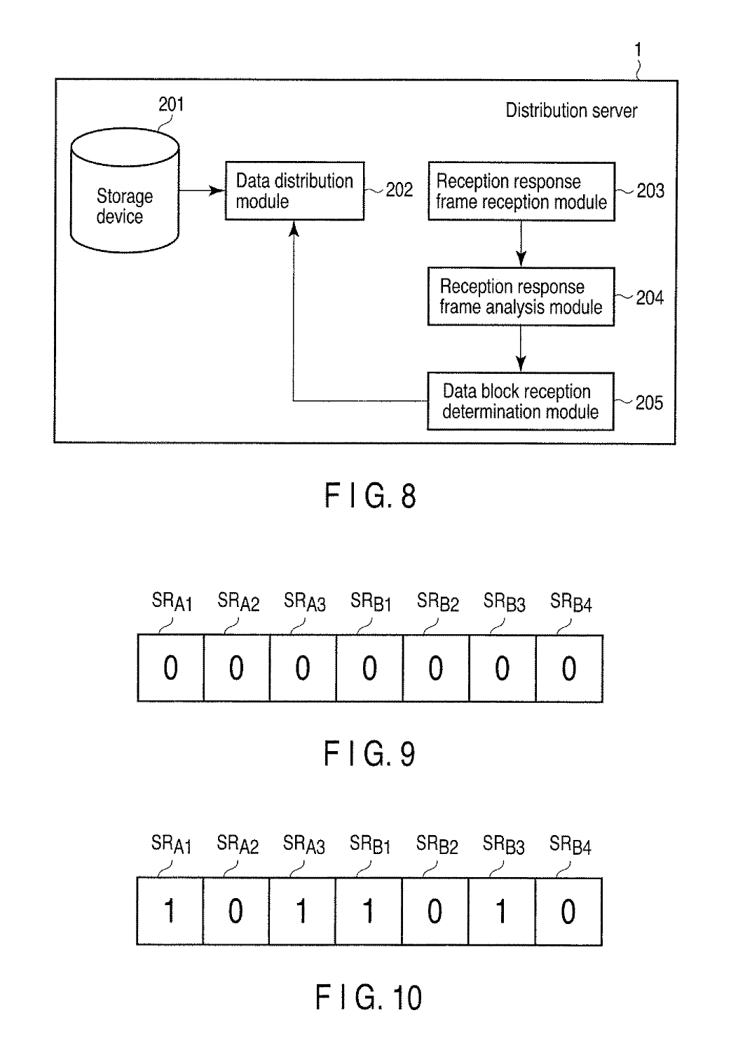

Next, the configuration of the distribution server will be explained by referring to FIG. 8. FIG. 5 shows a block diagram illustrating the configuration of the distribution server 1.

The distribution server 1 includes a storage device 201, a data distribution module 202, a reception response frame reception module 203, a reception response frame analysis module 204, and a data block reception determination module 205.

The storage device 201 stores data files to be distributed to respective distribution clients. The data distribution module 202 divides the data files stored in the storage device 201 into a plurality of data blocks to distribute the divided data blocks to all the distribution clients by multicast communication in turn. The reception response frame reception module 203 receives the reception response frames transmitted from each client. The reception response frame analysis module 204 analyzes the response frames received by the reception response frame reception module 203 to detect the distribution client that has received the data blocks distributed from the data distribution module 202.

The reception response frame analysis module 204 has the data reception client information showing the detected distribution client. The data reception client information is composed of the registers SR_{A1}, SR_{A2}, SR_{A3}, SR_{B1}, SR_{B2}, SR_{B3}, and SR_{B4} corresponding to all the clients as shown in FIG. 9.

The default value of each register is equivalent to “0” indicating non-reception as shown in FIG. 9. If the reception response frame analysis module 204 detects that a certain client has received the data block, the reception response frame analysis module 204 computes a logical multiplication “AND” of the value of the register corresponding to the client that has received the data block and “1” indicating that has been received to update the value of the register to the computation result.

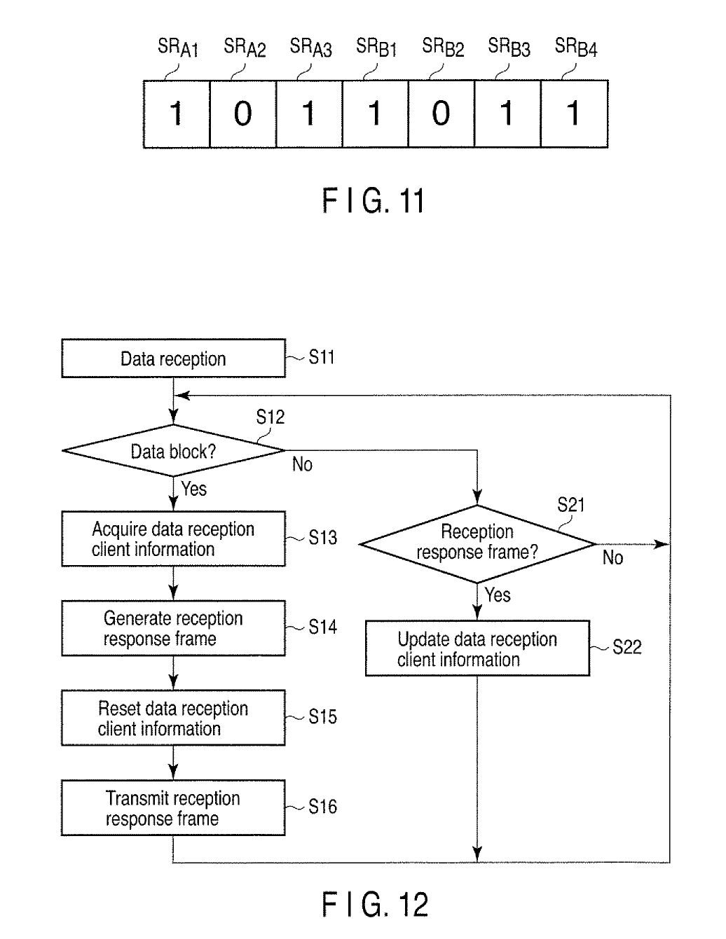

For instance, when the distribution server 1 receives the reception response frame shown in FIG. 4, in the data reception client information of FIG. 10, the value of the register SR_{A1} corresponding to the 11th distribution client A1, the value of the register SR_{A3} corresponding to the 13th distribution client A3, the value of the register SR_{B1} corresponding to the client 21st distribution client B1, and the value of the register SR_{B3} corresponding to the 23rd distribution client B3 are equivalent to “1”. In this state, when the distribution server 1 receives the reception response frames shown in FIG. 7, in the data reception client information of FIG. 11, the value of the register SR_{A1} corresponding to the 11th distribution client A1, the value of the register SR_{A3} corresponding to the 13th distribution client A3, the value of the register SR_{B1} corresponding to the 21st distribution client B1, and the value of the register SR_{B3} corresponding to the 23rd distribution client B3, and the value of the register SR_{B4} corresponding to the 24th distribution client B4 are equivalent to “1”.

The data block reception determination module 205 determines whether or not all the clients that have distributed the data blocks have received the data blocks from the data reception client information.

After the reception response frame analysis module 204 updates the data reception client information, the data block reception determination module 205 computes the logical multiplication of the values of all the registers. If the computation result of the logical multiplication is equivalent to “1”, the data block reception determination module 205 determines that all the clients have received the data blocks, and instructs the data distribution module 202 so as to distribute the next data block.

If it is determined that all the clients have received the data blocks, the data block reception determination module 205 instructs the data distribution module 202 so as to distribute the next data block. The data distribution module 202 instructs the reception response frame analysis module 204 so as to reset the value of each register of the data reception client information to “0”.

Next, the procedure of the processing performed by the distribution client during distribution will be described with reference to FIG. 12.

When the distribution client receives the data, the data sorting module 100 detects the kind of the data to determine whether or not the received data is a data block (Block S11). If it is determined that the received data is a data block (Yes. Block S11), the sorting module 100 transfers the received data to the data reception module 101 and instructs the generation module 104 to generate the reception response frame. The generation module 104 acquires data reception client information (Block S13). The generation module 104 generates the reception response frame including the information of the client and of its own module which has received the data block recorded in the data reception client information (Block S14). The generation module 104 instructs the reception response frame analysis module 103 to reset the data reception client information. The analysis module 103 resets the client information to set each register value to “0” (Block S15). The generation module 104 transfers the generated reception response frame to the reception response transmission module 105. The transmission module 105 transmits the reception response frame to the distribution server 1 and other distribution clients by multicast communication (Block S16).

In Block S11, if it is determined that the received data is not a data block (No, Block S11), the sorting module 100 determines whether or not the data is a reception response frame (Block S21). If it is determined that the data is not a reception response frame (No, Block S21), the sorting module 100 performs processing corresponding to the received data. If it is determined that the data is a reception response frame (Yes, Block S21), the sorting module 100 transfers the received data to the analysis module 103. The analysis module 103 analyzes the reception response frame to detect the distribution client that has already detected the data block. Based on the detected client, the analysis module 103 updates the data reception client information (Block S22).

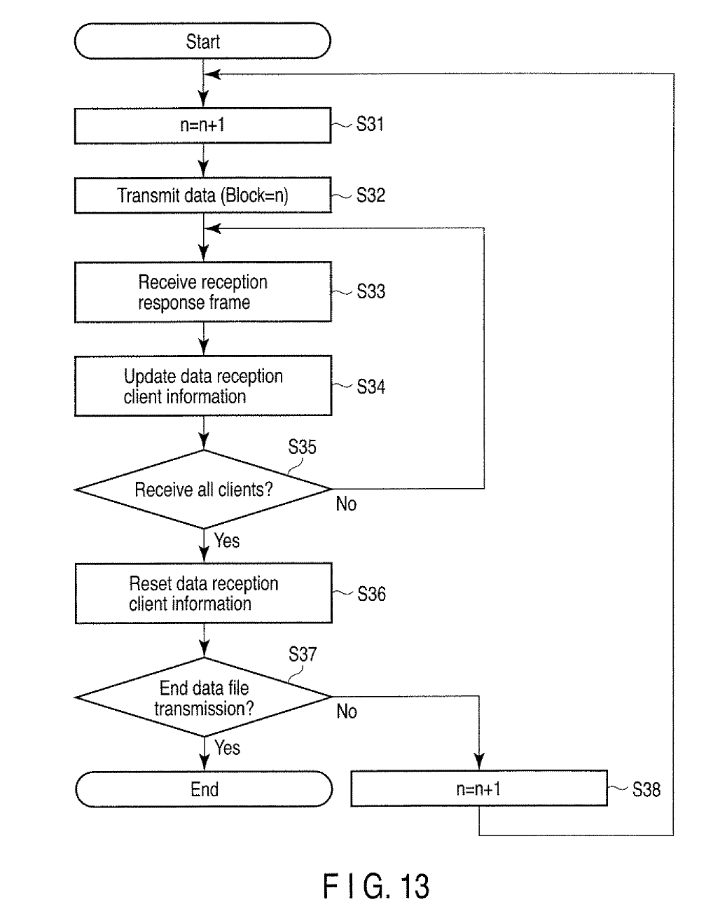

Next, the procedure of the processing performed by the distribution server 1 during distribution will be explained by referring to FIG. 13.

Firstly, the data distribution module 202 defines “n” as “0” (Block S31). The distribution module 202 transmits the n-th data block in the data files to the distribution clients A1, A2, A3, B1, B2, B3, and B4 by multicast (Block S32). After transmission, the reception response frame reception modules 203 receives the reception response frames from the reception modules 203 of any one of the distribution clients A1, A2, A3, B1, B2, B3, and B4 (Block S33). The reception modules 203 transfer the received reception response frame to the reception response frame analysis module 204. The analysis module 204 detects the distribution client that has already received the n-th data block to update the data reception client information (Block S34). The analysis module 204 reports that the data reception client information has been updated to the data block reception determining module 205. The determining module 205 determines whether or not all the distribution clients that have transmitted the n-th data block have received the data on the basis of the data reception client information have received the n-th data block (Block S35). If it is determined that all the distribution clients have not received the data (No, Step S35), the processing in Steps S33-S35 is executed in turn. If it is determined that all the distribution clients have received the n-th data block (Yes, Block 535), the determination module 205 instructs the analysis module 204 to reset the data reception client information. The analysis module 204 sets the values of all the registers SR_{A1}, sR_{A3}, sR_{B1}, SR_{B2}, SR_{B3}, and SR_{B4} to “0” to reset the data reception client information (Block S36). The determination module 205 determines whether or not the transmission of all the data files has completed (Block S37). If it is determined that the transmission has not completed (No, Block 537), the determination module 205 instructs the data distribution module 202 to distribute the next data block. The data distribution module 202 computes “n+1” to define the computed value as a value of a new “n” (Step S38). If it is determined that the transmission has completed (Yes, Block S37), the processing of the transmission of the data files ends.

The execution of the forgoing processing releases the information on the distribution client even if the information of the distribution client has been lost on the network and has not reached the distribution server 1. The execution thereof enables constructing a distribution system of high quality and high performance. For instance, even if the distribution server 1 has not received the response frame transmitted from the 11th distribution client A1 due to some reason, as long as the 24th distribution client B4 has received the response frame, since the response frame of the 11th distribution client A1 is included in the response frame of the 24th distribution client B4, the transmission of the distribution client A1 is confirmed.

While in the aforementioned embodiment, the distribution client A1 adopts operation specifications in which all other multicast responses which have already received include in the own response frame [“which have already been received are included in the response frame”?], it may be selected whether the distribution client transmitting the reception response frame should report to the distribution server 1 with inclusion of information on other distribution clients or should report to the distribution server 1 with only the reception response of the individual distribution client and without including the information on other distribution clients based on increased performance or reduction in load.

Utilizing this function enables an alternative reception response. For instance, the 12th distribution client A2 may be operated to include the response of the 11th distribution client A1 into its own response.

The distribution client can predict when the packet transmitted from the distribution server 1 has been lost on the basis of the other items of the distribution client reception response frame information, therefore an optimum distribution system can be constructed in consideration of a network burden, etc.

The multicast address for use in the distribution server and the multicast address for use in the distribution client may be the same or may not be the same as each other.

The responses from the distribution server and the distribution client may not be by multicast but may be by broadcast.

The distribution client transmitting the reception response frame may be configured to select whether reports to the distribution server by including the information of already received other distribution clients or reports solely its own reception response without including the information on the other distribution clients.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data reception device receiving data distributed by broadcast communication from a distribution server, comprising:
a data reception module configured to receive the data distributed from the distribution server by broadcast communication to one or more other data reception devices including a first data reception device and to the data reception device;
a reception response information reception module configured to receive reception response information, being transmitted by broadcast communication from the first data reception device to the distribution server and to the data reception device, and data reception devices except the first data reception device from the plurality of data reception devices, and including data reception device information showing data reception devices which have already received the data among the plurality of data reception devices when the first reception device receives the data; and
a detection module configured to detect other data reception devices which have already received the data among one or more other data reception devices on the basis of data reception device information in the reception response information received by the reception response information reception module; and
a reception response transmission module configured to transmit reception response information including data reception device information showing the other data reception devices and the data reception device detected by the detection module when the data reception module has received the data.

2. The device of claim 1, wherein the data has been transmitted by a multicast system or by a broadcast system.

3. The device of claim 1, wherein the reception response transmission module is configured to transmit the reception response information by a multicast system or by a broadcast system.

4. A data transmission device transmitting data by broadcast communication, comprising:
a data transmission module configured to transmit the data to a plurality of data reception devices including a first data reception device by broadcast communication;
a reception response information reception module configured to receive reception response information, being transmitted by broadcast communication from the first data reception device to the data transmission device and to data reception devices except the first data reception device from the plurality of data reception devices, and including first data reception device information showing reception data reception devices which have already received the data among the plurality of data reception devices when the first data reception device has received the data;
a detection module configured to detect data reception devices which have already received the data among the plurality of data reception devices on the basis of first data reception device information included in the reception response information every time the reception response information reception module has received reception response information;
a second data reception device information update module configured to update second data reception device information indicating data reception devices which have already received the data among the plurality of data reception devices on the basis of information of data reception devices which have already received the data among the plurality of data reception devices detected by the detection module every time the detection module detects the data reception device which has received the data among the plurality of data reception devices; and
a determination module configured to determine whether all the plurality of data reception devices have received data transmitted from the data transmission module on the basis of second data reception device information every time the second data reception device update module has updated the second data reception device information.

5. The device of claim 4, wherein the data transmission module transmits the data by a multicast system or by a broadcast system.

6. The device of claim 4, wherein the data is a data file which is divided into a plurality of data blocks, and the data transmission module transmits a data block not transmitted yet when the determination module determines that all the data reception devices have received the data.

7. A data distribution method, comprising:
transmitting data to a plurality of data reception devices including a first data reception device and a second data reception device from a data transmission device by broadcast communication;
receiving, by second data reception device, reception response information, being transmitted from the first data reception device to the distribution server and to data reception devices except the first data reception device from the plurality of data reception devices, and including first data reception device information showing reception data reception devices which have already received the data among the plurality of data reception devices when the first data reception device has received the data;
detecting, by the second data reception device, data reception devices which have already received the data among the plurality of data reception devices on the basis of first data reception device information;
transmitting reception response information including first data reception device information showing a data reception device and the second reception device detected by the detection module from the second reception device to the distribution server and to the plurality of data reception devices except the second reception device when the second data reception device has received the data;
receiving reception response information, by the data transmission device, transmitted from one data reception device among the plurality of data reception devices;
detecting data reception devices which have already received the data among the plurality of data reception devices on the basis of first data reception device information included in the reception response information every time the data transmission device has received the reception response information;
updating second data reception device information indicating data reception devices which have already received the data among the plurality of data reception devices detected by the detection module every time the data transmission device has detected the data reception device which has received the data among the plurality of data reception devices; and
determining whether all the data reception devices have received data transmitted from the data transmission module on the basis of second data reception device information every time the data transmission device has updated the second data reception device information.

8. The method of claim 7, wherein the data transmission device transmits the data by a multicast system or by a broadcast system.

9. The method of claim 7, wherein the data reception device transmits the reception response information by a multicast system or by a broadcast system.

10. The method of claim 7, wherein the data is a data file which is divided into a plurality of data blocks, and
the data transmission device transmits data blocks which have not transmitted yet, when it is determined that all the data reception devices have received the data.
